(19) United States
(12) Patent Application Publication
(10) Pub. No.: US 2024/0268275 A1
(43) Pub. Date: Aug. 15, 2024

(54) ADJUSTABLE SEPARATION SHEERS

(71) Applicant: Fiskars Finland Oy Ab, Espoo (FI)

(72) Inventors: Niko Rusanen, Espoo (FI); Mikko Heine, Espoo (FI); Janne Pärssinen, Helsinki (FI); Joska Heikkilä, Helsinki (FI); Joonas Vartola, Helsinki (FI)

(21) Appl. No.: 18/107,698

(22) Filed: Feb. 9, 2023

(51) Int. Cl. A01G 3/037

(52) U.S. Cl. CPC A01G 3/037

(57) ABSTRACT

A shear device includes at least one movable blade movable relative to a further member to provide a cutting mechanism in use. At least one of the blade and the further member are movable via a motor. An input is configured to allow selection of a maximum separation between the blade and the further member, where the input is configured to allow continuous selection of the maximum such that the maximum separation between the blade and the further member can be varied continuously accordingly.

### BACKGROUND

Pruning shear, or secateurs, are typically used to cut small branches from plants. Conventional pruning shears have blades with handles, provided in an X-shaped arranged. The use brings the handles together to close the blades to provide a cutting action.

Prior art shears are shown in US 2012/0246942. The blades 5, 6 of the shears are electrically actuated via a motor. A switch 9 allow variations of the maximum spacing or separation of the blades. For example, in position A, the motor is deactivated, preventing opening of the jaws. In position B, the jaws are openable to provide a large stroke angle for thick branches. In position C, the jaws are openable to provide an intermediate stroke angle for thin branches.

The inventor has found that the system only two distinct openable positions, and so the number of configurations is limited. The blades also only open to their maximum separation upon depression of a trigger, and thus it is difficult for the user to determine is the spacing selection is suitable.

The present invention aims to overcome or ameliorate one or more of the above problems.

### SUMMARY

According a first aspect of the invention, there is provided: a tool device comprising: at least one movable member movable relative to a further member, at least one of the movable member and the further member movable via a motor; and an input configured to allow selection of a maximum separation between the movable member and the further member.

The tool device may comprise a shear device. The movable member may comprise a blade. The movable member and the further member may comprise a cutting mechanism.

The input may be configured to allow continuous selection of the maximum (e.g. such that the maximum separation between the blade and the further member can be varied continuously accordingly).

Spacing of the cutting mechanism may be electronically controlled. Movement of the motor may be controlled via an electronic controller. The controller may be configured to move the blade in accordance with maximum separation provided by the input.

The controller may be configured to move the movable blade to the maximum separation to response to selection of the maximum separation via the input. The input and the movable blade may act in concert. The input and the movable blade may act in concert to provide visual feedback to the user. Movement of the input and the movable blade may be synchronous.

The controller may be configured to determine whether the maximum extension is reached using a driving speed of the motor.

The device may a sensor to determine a position of the motor or movable blade. The controller may be configured to determine whether the maximum extension is reached using said senor.

Where when the input is in a first position, the device may be configured to deny to power to the motor. The first position may provide an OFF or unpowered position.

The controller may be configured to close the blades/cutting mechanism when the input is moved to the first position.

The device may comprise a manual actuator configured to control the motor to effect movement of the blade. The actuator may be separate/spaced from the input.

The input may be spaced further from the blade than the actuator.

The actuator may be configured to control both opening and closing of the cutting mechanism. The input may be provided on or by the actuator.

The further member may comprise a blade or anvil. The input may comprise a slider. The maximum separation may comprise an angular separation. The shears may handheld. The shears may be powered via a battery.

The device may comprise a handle portion. The device may comprise a head portion. The head portion may be wider than and/or project outwardly from the handle portion. The head portion may enclose a portion of the blades and/or an actuation mechanism thereof.

According a further aspect of the invention, there is provided: a method of operating a shear device comprising at least one movable blade movable relative to a further member to provide a cutting mechanism in use, at least one of the blade and the further member movable via a motor; and selecting a maximum separation between the blade and the further member.

The method may provide continuous selection of the maximum (e.g. such that the maximum separation between the blade and the further member can be varied continuously accordingly).

The method may comprise moving the movable blade to the maximum separation to response to selection of the maximum separation via an input. The input and the movable blade may move in concert.

Any aspect of the invention may be combined with any other aspect of the invention where practicable.

### BRIEF DESCRIPTION OF THE FIGURES

Embodiments of the present invention are described below, by way of example only, with reference to the accompanying drawings:

FIG. 1 shows a perspective view of a shear device with blades in a closed position;

FIG. 2 shows a perspective view of a shear device with blades in an open position;

FIG. 3 shows a sectional view of a shear device with blades in a closed position;

FIG. 4 shows a sectional view of a shear device with blades in an open position;

FIG. 5 shows a schematic view of an electronic system of the shear device.

### DETAILED DESCRIPTION

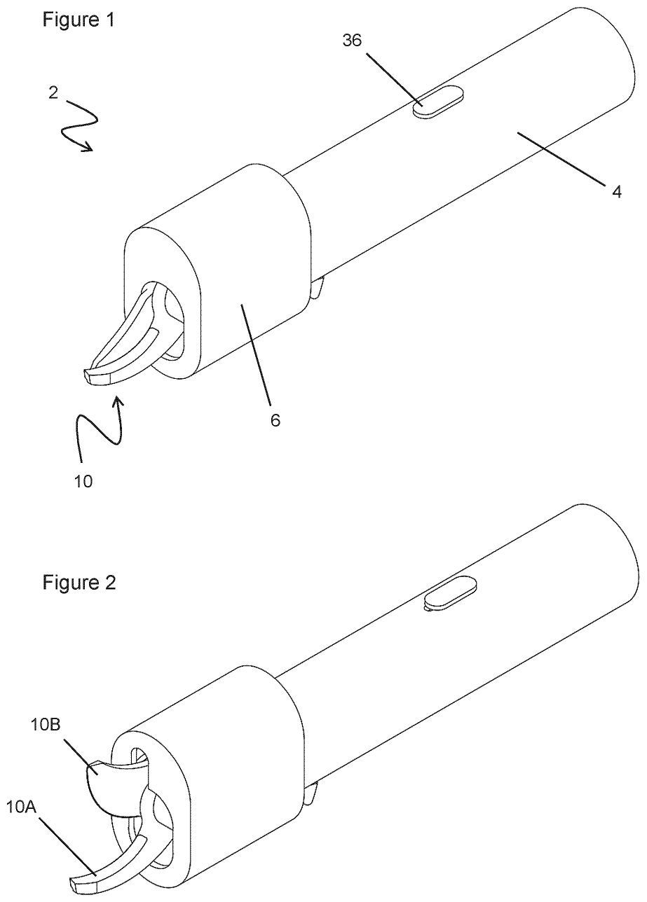

Pruning shears 2, also known as secateurs or hand pruners, are shown in FIGS. 1-4. The shears 2 are configured to be held in a hand of a user (i.e. are handheld). The shear 2 are portable. The shears 2 comprise a handle portion 4. The handle portion 4 is configured to be held by the user. The handle portion 4 comprises a generally elongate shaft. The handle portion 4 may comprise a circular or ovate cross-section. The handle portion 4 may comprise one or more grip surface (e.g. rubberised portion), and/or the handle portion 4 may be shaped to accommodate a hand and/or fingers.

A head portion 6 is provided at an end of the handle 6. The head portion 6 is configured to contain an actuation mechanism 8 for a cutting mechanism. The head portion 6 comprises a housing or casing. The portion 6 comprises a circular/ovate cross-section (i.e. similar to the handle 4). The head portion 6 projects outwardly from the handle 4 (i.e. to provide a bulbous or flanged arrangement). This may help to locate the shear 2 in the user's hand.

The cutting mechanism comprises blades 10. The blades 10 are arranged in a conventional fashion and comprise a conventional form. The blades provide a “bypass” arrangement. In the present embodiment, the first blade 10A is fixed relative to the head/handle. A second blade 10B is movable relative to the first blade 10A and the head/handle, thereby providing a cutting mechanism. It can be appreciated in others embodiment, the first blade 10A is movable and the second blade 10B is fixed, or both blades 10A,B are movable.

In some embodiments, only a single blade 10 is provided and the blade engages an anvil or mandrel. In some embodiments, the blades 10 may comprises a straight cutting edge (i.e. to provide a parrot-beak arrangement).

The movable blade 10B is driven via an electric motor (not shown). A power supply 12 provides power to the motor. In the present embodiment, the power supply comprises a battery. The battery may comprise a Lithium ion or Nickel based battery technology. In embodiments, the power supply may be wired (e.g. from a mains). The movable blade 10B comprise a gear portion 14 configured to be engaged by a gear on the motor to effect movement thereof. The gear may comprise a bevel gear.

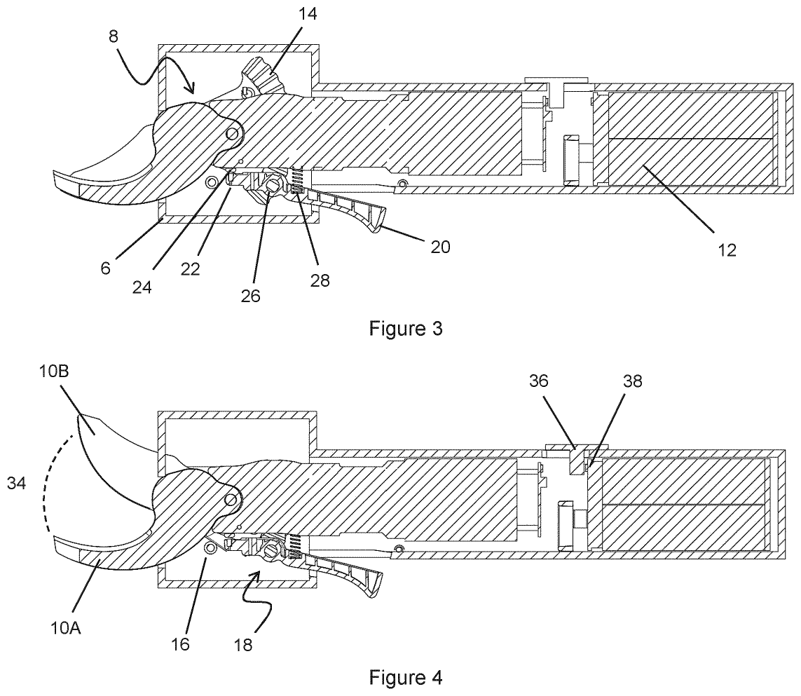

A manual actuator 18 is provided. The manual actuator 18 is configured to allow the user to provide movement of the blades toward a closed position (in FIGS. 1 and 3) and/or the open position (in FIGS. 2 and 4). The actuator 18 comprises an armature or trigger 20. An engagement portion 22 is configured to engage an actuation sensor 24. When the engagement portion 22 disengages or engages the sensor 24, a signal is triggered. The actuator 18 is pivotally mounted to the shear 2 via a pivot 26. The pivot 26 is provided within the head 6, such that the trigger 20 protrudes therefrom. Thus, when the trigger 20 is depressed or released, the engagement portion 22 disengages or engages the sensor 24 accordingly. A spring 28 biases the actuator 18 into the engaged position.

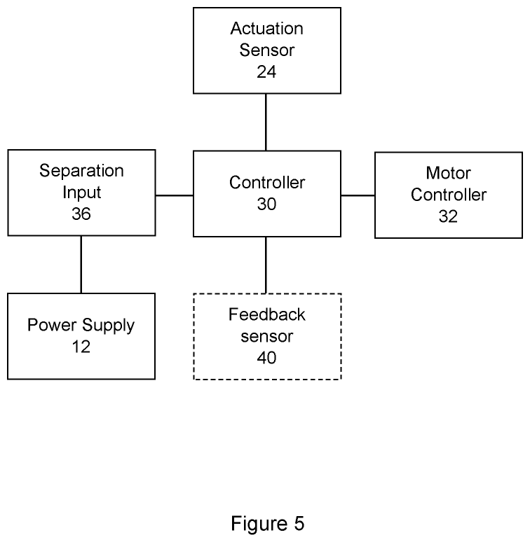

In the present embodiment, the sensor comprises a contact sensor 24. Thus, when the engagement portion 22 disengages the sensor 24, the sensor 24 sends a signal to a controller 30 (see FIG. 5). In turn, the controller 30 provides a signal to a motor controller 32 (or directly to the motor) to effect movement of the blade 10B. It can be appreciated that the sensor may comprise any suitable form, such as a magnetic, optical or pressure sensor etc.

In the present embodiment, both opening and closing the blades 10A,B is provided using the single actuator 18. Opening and closing of the blades 10A,B is provided by a particular actuation pattern of the actuator 18. Typically, this is provided by opening the blades 10A,B with a first actuation and then closing the blades 10A,B using a separate subsequent actuation. The user can therefore alternative the blade position by repeatedly depressing the actuator 18. The process can be repeated for each cutting sequence. This provides simple configuration, and for example, may prevent the user accidently closing the blade when they meant to open the blades etc.

In some embodiments, the actuator 18 may initiate the closing stroke, however, the device 2 is configured to automatically return to the open position (i.e. only a single depression of the trigger 20 is needed for both the closing and opening stroke). In other embodiments, respective actuators 18 are provided for the opening and closing movements. In some embodiments, a single actuator 18 may be provided, however, a second actuator/switch may be used to select whether the actuator 18 provides opening or closing of the blades 10A,B.

In the open position, the blades 10A,B are spaced by a separation 34. In the present embodiment, as the blades 10A,B are pivotally connected, the separation 34 provides an angular separation. In embodiments, where the blades a linearly movable with respect to one another, the separation may comprise a linear spacing. A maximum separation is defined as the separation 34 when the blades 10A,B are maximally spaced from one another. The maximum separation thus defines the maximum spacing (angular or otherwise) between the blades 10A,B. The maximum separation may define a stroke or sweep length.

The maximum separation is adjustable by the user. Thus, the sweep angle or stoke length of the movable blade or blades is adjustable. This allows the user to adjust the effective spacing of the blades 10A,B in the open position. This may allow quicker operation of the device (i.e. as travel time in the opening/closing cycle is reduced) and/or may help to increase the safety thereof (e.g. reduces the possibility of a finger or other body part being inserted between the blades 10A,B).

An input 36 is provided to allow variation of the maximum separation. The input comprises a switch or the like. In the present embodiment, the switch 36 comprises a slider. The slider 36 may therefore be slidable to vary the maximum separation. The input 36 is continuously or steplessly movable (i.e. between a near infinite number of positions). The maximum separation is thus continuously variable accordingly. This provides a more flexible configuration, as any maximum separation can be used.

A sensor arrangement is configured to detect the position of the input 36. The sensor may comprise any suitable position sensor. For example, a potentiometer may be used. The input 36 thus comprises a manual sensor.

The input 36 is provided on the handle 4. The input 36 is provided on the opposing side to the actuator 18. The input 36 is spaced from the head 6 and/or actuator 18. The input 36 is therefore further from the blade 10 than the actuator 18. This allows actuation of the input by a user's second hand, when a first hand is using the trigger. This allows the user to have greater control over the device. Indicia may be provided adjacent the input 36 to indicate the corresponding maximum separation.

In other embodiments, the input 36 is provided on the side as the actuator 18. For example, the input 36 may axially be space from the actuator 18 or may be provided on/within the trigger 20. This allows a single hand to operate opening/closing and vary the blade spacing. In some embodiments, the maximum spacing may be adjusted using the actuator 18. For example, a switch could be provided that allows selection between a maximum separation mode and the opening/closing mode. The user can move the switch and use the trigger to adjust the maximum spacing or provide opening/closing accordingly.

It can be appreciated that the input 36 may comprise any suitable form, for example: a rotatable dial; a lever; or depressible button. In some embodiments, one input may be provided to increase the maximum spacing and a second input may be used to decrease the maximum spacing. In some embodiments, the maximum spacing may be electronically/digitally variable. For example, the user may input a particular spacing or increase the spacing on an arbitrary scale. It can be appreciated that some quantisation of the maximum spacing may be provided (e.g. due to finite sensor or motor sensitivity), however, typically at least 20, or at least 50, increments are provided, such that the maximum spacing is effectively continuous in real world use.

In a first position (e.g. that shown in FIG. 4), the input 36 is configured to provide an “OFF” or unpowered state. In the present embodiment, power to the motor is denied when in the OFF position. The blades are thus rendered immobile.

In some embodiments, the input 36 engages a switch 38 which simply disconnects the power supply 12 from the controller 30 and/or motor. In other embodiments, the controller 30 prevents power to the motor (but may still receive power). Such an arrangement may help to ensure that power is not disconnected before the blades are fully closed.

In some embodiments, the blades 10A,B may move to the maximum spacing in concert or synchronously with the movement of the input 36 (e.g. in real time and without actuation of the trigger 18). The movable blades or blade thus move in concert with movement of the input 36. This allows the user to observe the maximum spacing before use. If the blades 10A,B are provided in an open position when the input 36 is moved to the OFF position, then the blades 10A,B are closed accordingly. The blades 10A,B are thus closed in a controlled way.

In other embodiments, the maximum spacing is determined by the controller 30, and the blades 10A,B only move toward the maximum spacing only once the trigger 18 is actuated. Such an arrangement requires two, separate actions by the user, providing improved safety.

In the present embodiment, the maximum separation of the blades 10A,B is electronically controlled. The controller 30 receives signal from the input 32 indicative of the maximum separation of the blades 10A,B. During the opening of the blades 10A,B, the controller 30 provides a signal to the motor/motor controller 32 to move the blades 10A,B only to the extent of the maximum separation. This may be determined using a number of methods. For example, if the motor operates at a given linear/angular speed, then the maximum separation is simply a function of time. For a separation of 30 degrees, the motor is activated for X seconds and for a separation of 60 degrees, the motor is activated for 2X seconds.

In some embodiments, a sensor 40 is provided to determine the position of the blade and/or motor. The controller 30 can therefore determine whether the maximum separation has been reached, and drive the motor accordingly. The operation of the motor is therefore determined via a feedback mechanism.

The maximum separation is typically less than or equal to 90 degrees, preferably less than or equal to 70 degrees, preferably less than or equal to 60 degrees.

### OPERATION

The user holds the shears 2 with a first hand on the trigger 20. A second hand may hold the handle 4 adjacent the battery 12. The thumb of the second hand can adjust the input 36. The user slides the slider 36, and the movable blade 10B moves in concert therewith. The user can adjust the slider 36 until the desired separation is achieved. The user than depresses the trigger 20 to initiate the closing cycle. The blades 10A,B may then open automatically or with a second depression of the trigger 20, depending on the configuration.

Once the user is finished, the slider 36 is moved toward the OFF position. The blades 10A,B close with said movement, until the blades are completely closed. To use the shear again, the user slides the slider 36 back toward the desired position, and the process is repeated.

The present arrangement allows continuous (i.e. stepless) variation of the maximum separation, thereby allowing a flexible and adjustable configuration. The device allows the user to select and visually determine the appropriate spacing before use thereof. The shear is typically operated using a two-handed configuration, thus improving the safety thereof.

What is claimed is:

1. A shear device comprising:
at least one movable blade movable relative to a further member to provide a cutting mechanism in use, at least one of the blade and the further member movable via a motor; and
an input configured to allow selection of a maximum separation between the blade and the further member, where the input is configured to allow continuous selection of the maximum separation such that the maximum separation between the blade and the further member can be varied continuously accordingly.

2. The shear device according to claim 1, where movement of the motor is controlled via an electronic controller, and the controller is configured to move the blade in accordance with maximum separation provided by the input.

3. The shear device according to claim 2, where the controller is configured to move the movable blade to the maximum separation in response to selection of the maximum separation via the input such that the input and the movable blade act in concert.

4. The shear device according to claim 2, where the controller is configured to determine whether the maximum separation is reached using a driving speed of the motor.

5. The shear device according to claim 2, comprising a sensor to determine a position of the motor or movable blade, and the controller is configured to determine whether the maximum separation is reached using said senor.

6. The shear device according to claim 1, where when the input is in a first position, the device is configured to deny power to the motor.

7. The shear device according to claim 6, where the controller is configured to close the cutting mechanism when the input is moved to the first position.

8. The shear device according to claim 1, comprising a manual actuator configured to control the motor to effect movement of the blade, the actuator spaced from the input.

9. The shear device according to claim 8, where the input is spaced further from the blade than the actuator.

10. The shear device according to claim 8, where the actuator is configured to control both opening and closing of the cutting mechanism.

11. The shear device according to claim 1, where the further member comprises a blade or anvil.

12. The shear device according to claim 1, where the input comprises a slider.

13. The shear device according to claim 1, where the separation maximum comprises an angular separation.

14. The shear device according to claim 1, where the shears are handheld and are powered via a battery.

15. A shear device comprising:
at least one movable blade movable relative to a further member to provide a cutting mechanism in use, at least one of the blade and the further member movable via a motor;
and an input configured to allow selection of a maximum separation between the blade and the further member; and
a controller configured to control movement of the cutting mechanism, and where the controller is configured to move the movable blade to the maximum separation to response to selection of the maximum separation via the input such that the input and the movable blade act in concert.
